(19) United States
(12) Patent Application Publication
(10) Pub. No.: US 2026/0122411 A1
(43) Pub. Date: Apr. 30, 2026

(54) ADAPTATING A MICROPHONE ARRAY TO A TARGET BEAMFORMER

(71) Applicant: Northwestern Polytechnical University, Xi'an (CN)

(72) Inventors: Chao PAN, Xi'an (CN); Jingdong CHEN, Xi'an (CN)

(73) Assignee: Northwestern Polytechnical University, Xi'an (CN)

(21) Appl. No.: 19/157,513

(22) PCT Filed: Mar. 3, 2023
(86) PCT No.: PCT/CN2023/079468

§ 371 Date: Aug. 18, 2025

(51) Int. Cl. H04R 1/40; H04R 3/00

(52) U.S. Cl. CPC H04R 1/406; H04R 3/005; H04R 2201/401; H04R 2201/403; H04R 2430/21

(57) ABSTRACT

A processing device, communicatively coupled to a microphone array with a first array geometry, may adapt the microphone array to a target beamformer associated with a target microphone array with a second array geometry. The processing device may, responsive to sound sources in a three-dimensional (3D) space, obtain a first plurality of electronic signals generated by the microphone array, divide a set of angles within the 3D space into J subsets of angles and identify a location of each sound source in the 3D space, with respect to the subsets of angles, based on the first plurality of electronic signals. An associated cost function may be evaluated for each frequency sub-band of a plurality of frequency sub-bands and for each subset of angles and a second plurality of electronic signals corresponding to the target microphone array may be generated based on the evaluation of the associated cost function.

### TECHNICAL FIELD

This disclosure relates to beamforming with microphone arrays and, in particular to adapting a microphone array having a specific microphone array geometry to a target beamformer associated with a different microphone array geometry.

### BACKGROUND

A differential microphone array (DMA) uses signal processing techniques to obtain a directional response to a source sound signal based on differentials of pairs of the source signals received by microphones of the array. DMAs may contain an array of microphone sensors that are responsive to the spatial derivatives of the acoustic pressure field generated by the sound source. A uniform DMA may include uniformly distributed microphones that are arranged on a common platform according to the microphone array's geometry (e.g., linear geometry, circular geometry or other array geometry).

The DMA may be communicatively coupled to a processing device (e.g., a digital signal processor (DSP) or a central processing unit (CPU)) that includes circuits programmed to implement a beamformer to calculate an estimate of the sound source. A beamformer can be a spatial filter that uses the multiple versions of the source sound signal captured by the microphones in the microphone array to identify the sound source according to certain optimization rules. A beampattern (also known as a directivity pattern) reflects the sensitivity of the beamformer to a plane wave impinging on the DMA from a particular angular direction.

### BRIEF DESCRIPTION OF THE DRAWINGS

The present disclosure is illustrated by way of example, and not by way of limitation, in the figures of the accompanying drawings.

FIG. 1 shows a block diagram illustrating a three-dimensional space including a microphone array and sound sources that include virtual sources based on reflections of real sound sources, according to implementations of the disclosure.

FIG. 2 shows a flow diagram illustrating a microphone array transform for generating observation signals of a target microphone array based on observation signals of a source microphone array, according to implementations of the disclosure.

FIG. 3 shows a flow diagram of a method for adapting a microphone array having a specific array geometry to a target beamformer associated with a different microphone array geometry, according to implementations of the disclosure.

FIG. 4 shows a graph of cost functions as a function of the iterations of an optimization, according to implementations of the disclosure.

FIG. 5 shows a graph of residuals as a function of the iterations of an optimization, according to implementations of the disclosure.

FIG. 6 shows a graph of a penalty factor as a function of the iterations of an optimization, according to implementations of the disclosure.

FIG. 7 shows a graph of the cost functions as a function of the sparseness of sound sources, according to implementations of the disclosure.

FIGS. 8A-8D show polar plots including the estimated value of weak sound sources for different levels of sound source sparseness, according to implementations of the disclosure.

FIGS. 9A-9D show polar plots including the estimated value of strong sound sources for different levels of sound source sparseness, according to implementations of the disclosure.

FIG. 10 shows a graph of a relative impulse responses as a function of a time index, according to implementations of the disclosure.

FIG. 11 shows a graph of a relative transfer functions as a function of a frequency, according to implementations of the disclosure.

FIG. 12 shows a graph of a signal distortion index as a function of a short-time objective intelligibility, according to implementations of the disclosure.

FIG. 13 shows a block diagram illustrating a machine, in the example form of a computer system, within which a set or sequence of instructions may be executed to cause the machine to perform any one of the methodologies discussed herein.

### DETAILED DESCRIPTION

Microphone arrays have been widely used to solve numerous acoustic problems such as speech enhancement, noise reduction, sound source separation, sound source localization, beamforming, sound field recording etc. Many algorithms have been developed to solve these acoustic problems. The difference between these algorithms may often be based on factors, such as, the principles of the determined variables, the framework of the processing, and/or the geometry of the microphone arrays. The microphone array geometry may be particularly relevant. In certain scenarios, the downstream applications may be customized for a particular beamformer (referred to as a target beamformer). When a product is configured with a new microphone array with a new geometric configuration, the new microphone array may need to be adapted to the target microphone array. An approach to generating the sound signal observations of a target microphone array having a specific array geometry (e.g., linear) by using the sound signal observations of a source microphone array (e.g., source of the sound signals that are actually observed) having a different array geometry (e.g., circular) is described herein.

Array geometries (e.g., relative position of array microphones with respect to a reference point) may have impacts on the uses of microphone arrays, such as, beamforming, multiple-output array processing, and/or sound source localization. Various types of beamforming exist, for example, adaptive beamforming, superdirective beamforming, and the widely-used differential beamforming etc. The differential beamforming may achieve the maximum array directivity by making the hypercardioid beampattern the target beampattern of the microphone array. However, the maximum order of the target beampattern depends on the geometry of the array, e.g., an M-element linear array may form an (M−1) order differential microphone array (DMA) so that, for example, a four-microphone linear array may be used to form a third order DMA. The maximum order of a circular microphone array is approximately M/2, and the maximum order of a spherical microphone array is even lower than M/2. A linear microphone array may only form an effective beampattern at the endfire directions, while a uniform circular microphone array and a concentric microphone array may have the ability to flexibly steer the beampattern towards many directions. Differential beamforming with a uniform linear array geometry may be designed and implemented in a multistage cascaded manner by approximating the differential operations with a finite order difference, while a similar framework could not generally be used for other array geometries. It is, therefore, very clear that an array's geometry is related to the performance and implementation of beamforming with the array.

Unlike the beamforming, multiple-output array processing algorithms have more than one output channel. A widely-linear filtering framework is described herein to preserve the spatial clues of the sound source while reducing the noise of observation signals from general microphone array with more than two sensors. For example, a complex neural network may be developed to reduce the noise of the observation signals and also to preserve any spatial clues of the source based on similar approaches. Since multiple-output array processing may preserve the spatial clues of the sound sources in the sound field, reference points may be taken from the positions of sensors of the array, which is simple in implementation but lacks flexibility.

Performance and implementation of sound source localization approaches may also highly depend on array geometries, e.g., spatial smoothing and gridless-direction-calculation may be readily developed based on linear array geometries. Although the geometry of an array may be useful in many array processing approaches, in practical situations, the array geometry is often determined by the design of a product. For example, it may be very difficult to put a 3D microphone array (e.g., spherical array geometry) into tablet shaped equipment, such as, a laptop computer, a TV, a cellphone etc. Therefore, a method for generating the signal observations of a target array with a specified geometry based on the signal observations of some other arrays with different array geometries is needed.

A microphone array transform which generates the expected sound signal observations of a target array with a specified array geometry based on the actual sound signal observations of a source array with a different array geometry is discussed herein. The number (M) of sensors of the source array and the number (N) the target array may be M and N, respectively. In the frequency domain, observations of the source (target) array at each frequency band may be expressed as a vector of length (N). Therefore, the array transform may apply a matrix of size M×N to the observations of the source array. Under a traditional signal model in the frequency domain, and following the naive principle of array transform, the challenges of the resulting array transform approaches can be difficult to overcome. However, the array signal models may be rewritten as functions of array manifold vectors and frequency-angle domain source signals. An estimate of the frequency-angle domain source signal may be determined by assuming that the sound sources are sparse in the angle domain, and building the optimization problem as a group lasso with complex variables. Details of the optimization problem, which include the iteration steps, the initialization, the penalty factor adaptation, the stop criterion etc., are explained more fully below with respect to the figures.

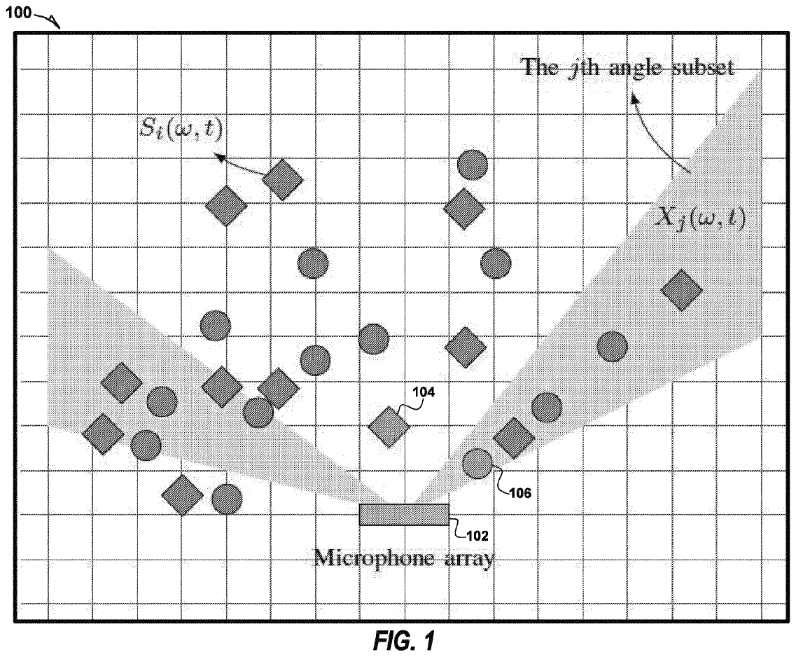

FIG. 1 shows a block diagram illustrating a three-dimensional space 100 including a microphone array 102 and sound sources that include virtual sources based on reflections of real sound sources 104 and 106, according to implementations of the present disclosure.

Two microphone arrays with different array geometries maybe considered with respect to 3D space 100. A first “source” array may include M sensors (e.g., microphones) and a second “target” array may include N sensors. The angular frequency and time frame index may be denoted as ω and t, respectively, and then the observations of the source and target arrays may be denoted as Yₘ(ω, t) and Zₙ(ω, t), respectively, with m (1, . . . , M) and n (1, . . . , N) being the respective sensor indexes. By re-writing the observations of the source and target arrays as vectors,

$$y ( ω , t ) {=}^{△} {[ \begin{matrix}{Y}_{0} ( ω , t ) & {Y}_{1} ( ω , t ) & ... & {Y}_{M - 1} ( ω , t )\end{matrix} ]}^{T} , \qquad ( 1 )$$

$$z ( ω , t ) {=}^{△} {[ \begin{matrix}{Z}_{0} ( ω , t ) & {Z}_{1} ( ω , t ) & ... & {Z}_{N - 1} ( ω , t )\end{matrix} ]}^{T} , \qquad ( 2 )$$

where the lengths of vectors y(ω, t) and z(ω, t) are M and N, respectively.

In order to generate the target array observation z(ω, t) based on the source array observation y(ω, t) a signal model may first be adopted. The acoustic transfer function (ATF) and the convolutive transfer function (CTF) models are often taken as the basic models for microphone array signal processing. However, the ATF and the CTF models may not be useful for the problem described above. For example, in the simple case that only one sound source signal is in the acoustic environment (e.g., sound source 104 in 3D space 100), the array observation under the ATF model may be expressed as

$$y ( ω , t ) = h ( ω ) S ( ω , t ) , \qquad ( 3 )$$

$$z ( ω , t ) = g ( ω ) S ( ω , t ) , where \qquad ( 4 )$$

$$h ( ω ) {=}^{△} {[ \begin{matrix}{H}_{0} ( ω ) & {H}_{1} ( ω ) & ... & {H}_{M - 1} ( ω )\end{matrix} ]}^{T} , \qquad ( 5 )$$

$$g ( ω ) {=}^{△} {[ \begin{matrix}{G}_{0} ( ω ) & {G}_{1} ( ω ) & ... & {G}_{N - 1} ( ω )\end{matrix} ]}^{T} \qquad ( 6 )$$

are the respective transfer function vectors of the two arrays with Hₘ(ω) and Gₙ(ω) being the transfer functions from the sound source to the m^{th} sensor of the first “source” array and the nth sensor of the second “target” array. However, the ATF model clearly fails to correctly model the array observations when a reverberation time (e.g., for a reflection of sound source 104) is greater than an observation frame length.

In the same situation with only one sound source signal in the acoustic environment (e.g., 3D space 100), the array observation under the CTF model may be expressed as

$$y ( ω , t ) = {\sum }_{k = 0}^{K - 1} {h}_{k} ( ω ) S ( ω , t - k ) , \qquad ( 7 )$$

$$z ( ω , t ) = {\sum }_{k = 0}^{K - 1} {g}_{k} ( ω ) S ( ω , t - k ) . \qquad ( 8 )$$

According to (7) and (8), if there exists a matrix of size N×M which satisfies

$$Q ( ω ) {h}_{k} ( ω ) = {g}_{k} ( ω ) , ∀ k = 0 , 1 , ... , K - 1 , \qquad ( 9 )$$

the observation of the target array may be generated according to

$$z ( ω , t ) = Q ( ω ) y ( ω , t ) . \qquad ( 10 )$$

However, such a method requires estimates of channel parameters hₖ(ω)'s and gₖ(ω)'s for all the sound sources. Despite the existence of the matrix Q(ω), estimating channel parameters in a real acoustic environment may often be difficult. Therefore, the popular ATF and CTF models may not be useful for the array transform, and directly applying a matrix Q(ω) to the array observations may be difficult as well.

As noted above with respect to reverberation times, the reflections of the sound source (e.g., sound source 104) may be viewed as virtual sound sources at different positions. In the case that there are L real and virtual sources in total, the angle of the i^{th} source may be denoted as φᵢ, the time delay from the i^{th} source to the reference position may be denoted as τᵢ, and the attenuation of the i^{th} source may be denoted as αᵢ(ω), and the signal “radiated” from the i^{th} sound source position may be denoted as Sᵢ(ω, t). With these denotations, the observations of the source and target microphone arrays may be expressed as

$$y ( ω , t ) = {\sum }_{i = 0}^{L} d ( ω , {φ}_{i} ) {α}_{i} ( ω ) {e}^{- J {ωτ}_{i}} {S}_{i} ( ω , t ) , \qquad ( 11 )$$

$$z ( ω , t ) = {\sum }_{i = 0}^{L} a ( ω , {φ}_{i} ) {α}_{i} ( ω ) {e}^{- J {ωτ}_{i}} {S}_{i} ( ω , t ) \qquad ( 12 )$$

respectively, where

$$d ( ω , φ ) {=}^{△} [ \begin{matrix}{e}^{J \frac{ω}{c}} {ξ}_{0}^{T} φ \\ {e}^{J \frac{ω}{c}} {ξ}_{1}^{T} φ \\ ⋮ \\ {e}^{J \frac{ω}{c} {ξ}_{M - 1}^{T} φ}\end{matrix} ] \qquad ( 13 )$$

$$a ( ω , φ ) {=}^{△} [ \begin{matrix}{e}^{J \frac{ω}{c} {ζ}_{0}^{T} φ} \\ {e}^{J \frac{ω}{c} {ζ}_{1}^{T} φ} \\ ⋮ \\ {e}^{J \frac{ω}{c} {ζ}_{N - 1}^{T} φ}\end{matrix} ] \qquad ( 14 )$$

are the array manifold vectors of the two arrays respectively, with c being the speed of sound in the air, the ξᵢ's being the positions of the sensors of the source array (e.g., according to the array geometry), and the ζᵢ's being the positions of the sensors of the target array.

According to (11) and (12), if a matrix Q(ω) satisfies

$$Q ( ω ) d ( ω , φ ) = a ( ω , φ ) , ∀ φ , \qquad ( 15 )$$

then the matrix Q(ω) may be applied to the array observation y(ω, t) to further generate the desired observation a(ω,t), i.e., (10). By minimizing the averaged-square-error (ASE), i.e.,

$$𝒥 {=}^{△} \frac{1}{4 π} {\int }_{0}^{π} {\int }_{0}^{2 π} {‖ Q ( ω ) d ( ω , φ ) - a ( ω , φ ) ‖}_{2}^{2} sin θ d θ d ϕ ,$$

the optimal Q(ω) and the minimum ASE may be derived as

$$Q ( ω ) = {Γ}_{ad} ( ω ) {Γ}_{dd}^{- 1} ( ω ) , \qquad ( 16 )$$

$${𝒥}_{min} = N - tr [ {Γ}_{ad} ( ω ) {Γ}_{dd}^{- 1} ( ω ) {Γ}_{ad}^{H} ( ω ) ] \qquad ( 17 )$$

$$= {\sum }_{n = 0}^{N - 1} [ 1 - {γ}_{n}^{H} ( ω ) {Γ}_{dd}^{- 1} ( ω ) {γ}_{n} ( ω ) ] , where \qquad ( 18 )$$

$${Γ}_{dd} ( ω ) {=}^{△} \frac{1}{4 π} {\int }_{0}^{π} {\int }_{0}^{2 π} d ( ω , φ ) {d}^{H} ( ω , φ ) sin θ d θ d ϕ , \qquad ( 19 )$$

$${Γ}_{ad} ( ω ) {=}^{△} \frac{1}{4 π} {\int }_{0}^{π} {\int }_{0}^{2 π} a ( ω , φ ) {d}^{H} ( ω , φ ) sin θ d θ d ϕ , \qquad ( 20 )$$

and the vector

$${γ}_{n}^{H} ( ω )$$

equals the n^{th} row of the matrix Γ_{ad} (ω), i.e., Γ_{ad}(ω)=[γ₀(ω)γ₁(ω) . . . γ_{N-1}(ω)]^{H}. In the specific case that N=1, e.g., to interpolate the signal of a certain position by the array observation, it may be verified that

$$Q ( ω ) = {γ}_{0}^{H} ( ω ) {Γ}_{d d}^{- 1} ( ω ) and {𝒥}_{min} = 1 - {γ}_{0}^{H} ( ω ) {Γ}_{d d}^{- 1} ( ω ) {γ}_{0} ( ω ) .$$

In view of (16) and (18) above, this method is clearly equivalent to interpolating the signals received from different sensor positions, independently, which may corrupt the inter-channel relation of the target array. This could make the resulting z(ω, t) difficult to use in various widely used array processing approaches.

The variables related to the source and the target arrays, respectively, are summarized in Table 1 below for reference.

TABLE 1

| | Source array | Target array |
|---|---|---|
| Number of sensors | M | N |
| Sensor index | m | n |
| Sensor position | ξₘ | ζₙ |
| Array observation | Yₘ(ω, t) | Zₙ(ω, t) |
| Array observation vector | y(ω, t) | z(ω, t) |
| Transfer function | Hₘ(ω) | Gₘ(ω) |
| Transfer function vector | h(ω) | g(ω) |
| Noise | Vₘ(ω, t) | Uₙ(ω, t) |
| Noise vector | v(ω, t) | u(ω, t) |
| Manifold vector | d(ω, φ) | a(ω, φ) |

| | |
|---|---|
| All the signal from j^{th} direction | Xⱼ(ω, t) |
| Virtual source at the i^{th} position | Sᵢ(ω, t) |

As shown in FIG. 1, the Sᵢ(ω, t) represent the virtual sound sources (e.g., based on reflections of the real sound sources) and the Xⱼ(ω, t) represent all of the sound signals coming from the j^{th} direction (as explained below) where the circle 106 and the diamond 104 are real sound sources and the others are virtual sources (e.g., the circles are reflections of circle 106 and the diamonds are reflections of diamond 104), and the frequency-angle domain source signal Xⱼ(ω, t) include more than one sound sources.

A set of angles (e.g., with respect to the source microphone array 102) within 3D space 100, e.g., {φ}, may be divided into J subsets of the angles, and a central angle of the j^{th} subset may be denoted as φⱼ. The angle of the i^{th} sources, i.e., φᵢ, may then be assigned to a jᵢ^{th} category and replaced by the central angle φⱼ_{ᵢ}, where

$${j}_{i} = arg {min}_{j} \int {\vert d ( ω , {φ}_{i} ) - d ( ω , {φ}_{j} ) \vert}^{2} d ω . \qquad ( 21 )$$

According to (11) and (12), we have

$$y ( ω , t ) \approx {\sum }_{i = 0}^{L} d ( ω , {φ}_{{j}_{i}} ) {α}_{i} ( ω ) {e}^{- j {ωτ}_{i}} {S}_{i} ( ω , t ) \qquad ( 22 )$$

$$= {\sum }_{j = 0}^{J - 1} d ( ω , {φ}_{j} ) {X}_{j} ( ω , t ) , \qquad ( 23 )$$

$$z ( ω , t ) \approx {\sum }_{i = 0}^{L} a ( ω , {φ}_{{j}_{i}} ) {α}_{i} ( ω ) {e}^{- j {ωτ}_{i}} {S}_{i} ( ω , t ) \qquad ( 24 )$$

$$= {\sum }_{j = 0}^{J - 1} a ( ω , {φ}_{j} ) {X}_{j} ( ω , t ) \qquad ( 25 )$$

$$where$$

$${X}_{j} ( ω , t ) {=}^{Δ} {\sum }_{i , {j}_{i} = j} {α}_{i} ( ω ) {e}^{- j {ωτ}_{i}} {S}_{i} ( ω , t ) . \qquad ( 26 )$$

The variable Xⱼ(ω, t) may be viewed as representing all of the source sound signals coming from the φⱼ^{th} direction. For convenience, Xⱼ(ω, t) may be referred to as the source sound signal in the frequency-angle domain throughout this disclosure.

The variable ω may be discretized as ω₀, ω₁, . . . , ω_{F-1}, and a matrix X of size F×J may be defined with its (i,j)^{th} element being X(ωᵢ, φⱼ). The corresponding j^{th} column and the i^{th} row of X may then be denoted as xⱼ and xᵢ, respectively, i.e.,

$${x}_{j} {=}^{Δ} [ \begin{matrix}{X}_{j} ( {ω}_{0} , t ) \\ {X}_{j} ( {ω}_{1} , t ) \\ ⋮ \\ {X}_{j} ( {ω}_{F - 1} , t )\end{matrix} ] , {\underline{x}}_{i} {=}^{Δ} [ \begin{matrix}{X}_{0} ( {ω}_{i} , t ) \\ {X}_{1} ( {ω}_{i} , t ) \\ ⋮ \\ {X}_{J - 1} ( {ω}_{i} , t )\end{matrix} ] , \qquad ( 27 )$$

$$X = [ \begin{matrix}{x}_{0} & {x}_{1} & … & {x}_{J - 1}\end{matrix} ] \qquad ( 28 )$$

$$= [ \begin{matrix}{\underline{x}}_{0}^{T} \\ {\underline{x}}_{1}^{T} \\ ⋮ \\ {\underline{x}}_{F - 1}^{T}\end{matrix} ] . \qquad ( 29 )$$

The argument t may be omitted in the notation of X, xⱼ and xᵢ, without causing any ambiguity. For convenience, the following definitions may be used

$${D}_{i} {=}^{Δ} [ \begin{matrix}d ( {ω}_{i} , {φ}_{0} ) & d ( {ω}_{i} , {φ}_{1} ) & … & d ( {ω}_{i} , {φ}_{L - 1} )\end{matrix} ] , \qquad ( 30 )$$

$${A}_{i} {=}^{Δ} [ \begin{matrix}a ( {ω}_{i} , {φ}_{0} ) & a ( {ω}_{i} , {φ}_{1} ) & … & a ( {ω}_{i} , {φ}_{L - 1} )\end{matrix} ] \qquad ( 31 )$$

where the sizes of Dᵢ and Aᵢ are M×J and N×J, respectively and the array observations may then be expressed, respectively, as

$$y ( {ω}_{i} , t ) = {D}_{i} {\underline{x}}_{i} , ∀ i = 0 , 1 , … , F - 1 , \qquad ( 32 )$$

$$z ( {ω}_{i} , t ) = {A}_{i} {\underline{x}}_{i} , ∀ i = 0 , 1 , … , F - 1 , \qquad ( 33 )$$

which may be used to derive a useful microphone array transform approach.

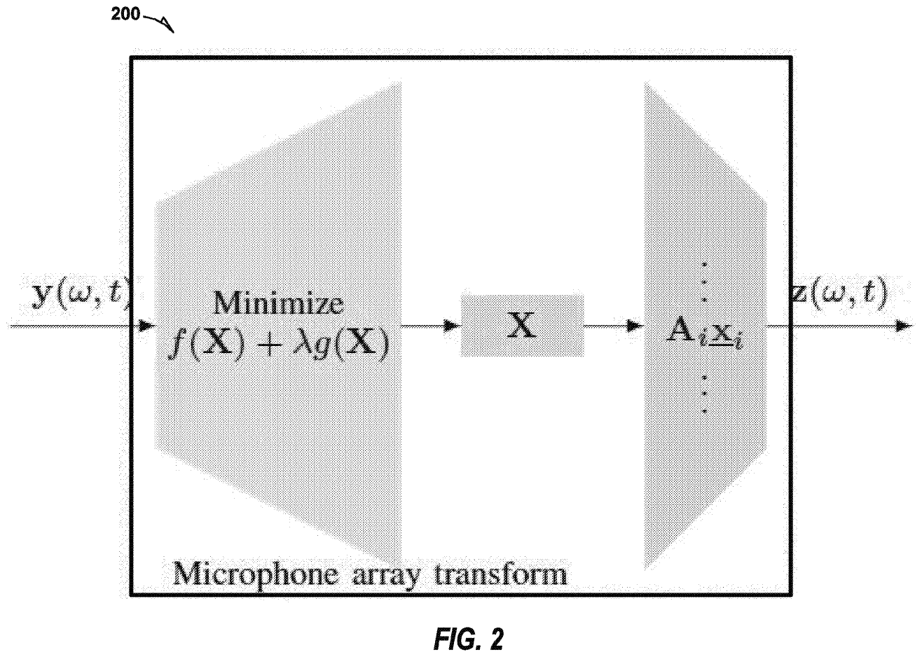

FIG. 2 shows a flow diagram illustrating a microphone array transform 200 for generating the observation signals of the target microphone array based on the observation signals of the source microphone array (e.g., microphone array 102 of FIG. 1), according to implementations of the disclosure.

In the case where an estimate of xᵢ, i.e., \hat{x}ᵢ, is available, the observation of the target array may be generated according to (33), i.e., z(ωᵢ, t)=Aᵢ\hat{x}ᵢ. Since y(ωᵢ, t) is the observation of the actual source array (e.g., microphone array 102 of FIG. 1), and Dᵢ is known beforehand, an estimate of xᵢ may be generated according to (32). The total number of variables to be determined is JF, while the total number of available equations is MF. Therefore, in order to have a meaningful solution, it is assumed that MF≥JF, i.e.,

$$M \geq J , \qquad ( 34 )$$

which means that the number of sensors M (e.g., of the actual source array) should be no less than the number J of the subsets of the angles. The corresponding cost function may be expressed as

$$f ( X ) = \frac{1}{2} {\sum }_{i = 0}^{F - 1} {‖ {D}_{i} {\underline{x}}_{i} - y ( {ω}_{i} , t ) ‖}_{2}^{2} . \qquad ( 35 )$$

In the case where the number of sensors is less than the number of the subsets of the angles, i.e., M<J, further assumptions may be made to guarantee a meaningful solution.

By ignoring the virtual sound sources (e.g., sound reflections) with small power, it may be assumed that the power of Xⱼ(ω, t) is sparse in the angle domain. Therefore, a second cost function may be expressed as

$$g ( X ) = {\sum }_{j = 0}^{J - 1} {‖ {x}_{j} ‖}_{2} . \qquad ( 36 )$$

By combining (35) and (36), an estimate of the X may be generated according to

$$\hat{X} = arg {min}_{X} f ( X ) + λ g ( X ) \qquad ( 37 )$$

$$= arg {min}_{X} \frac{1}{2} {\sum }_{i = 0}^{F - 1} {‖ {D}_{i} {\underline{x}}_{i} - y ( {ω}_{i} , t ) ‖}_{2}^{2} + λ {\sum }_{j = 0}^{J - 1} {‖ {x}_{j} ‖}_{2} , \qquad ( 38 )$$

where λ≥0 is a penalty factor, xᵢ is the i^{th} row of the X, and xⱼ is the j^{th} column of X. The solution to (38) will be discussed further below.

As shown in FIG. 2, the microphone array transform 200 takes y(ω, t), a vector of length M, as input, minimizes the cost functions ƒ(X) and g(X), and applies X, a matrix of size F×J, to generate z(ω, t), a vector of length N.

The alternating direction method of multipliers (ADMM) is an algorithm that solves convex optimization problems by breaking them into smaller pieces, each of which can then be easier to handle. The ADMM may be derived from real variables instead of complex ones and may be applied to solve (38) as presented above. The optimization problem may be re-expressed such that the argument is a real variable. For convenience, the following variables may be defined

$${\ddot{x}}_{j} {=}^{Δ} [ \begin{matrix}( {x}_{j} ) \\ ( {x}_{j} )\end{matrix} ] , \qquad ( 39 )$$

$${\ddot{x}}_{i} {=}^{Δ} [ \begin{matrix}( {\underline{x}}_{j} ) \\ ( {\underline{x}}_{j} )\end{matrix} ] , \qquad ( 40 )$$

$${D}_{i} {=}^{Δ} [ \begin{matrix}( {D}_{i} ) & - ( {D}_{i} ) \\ ( {D}_{i} ) & ( {D}_{i} )\end{matrix} ] , \qquad ( 41 )$$

$${\ddot{y}}_{i} {=}^{Δ} [ \begin{matrix}[ y ( {ω}_{i} , t ) ] \\ [ y ( {ω}_{i} , t ) ]\end{matrix} ] . \qquad ( 42 )$$

The cost functions ƒ(X) and g(X) may then be re-expressed as

$$f ( X ) = \frac{1}{2} {\sum }_{i = 0}^{F - 1} {‖ {\ddot{D}}_{i} {\ddot{x}}_{i} - {\ddot{y}}_{i} ‖}_{2}^{2} , \qquad ( 43 )$$

$$g ( X ) = {\sum }_{j = 0}^{J - 1} {‖ {\ddot{x}}_{j} ‖}_{2} . \qquad ( 44 )$$

Two matrices U and Z, which have the same size as X may be defined so that the solution to (38) may be iteratively determined according to the following steps:
1) Update the rows of X, i.e., ∀i=0, 1, . . . , F−1,

$${\underline{\ddot{x}}}_{i}^{( ℓ + 1 )} ← {( {\ddot{D}}_{i}^{T} {\ddot{D}}_{i} + ρ I )}^{- 1} [ {\ddot{D}}_{i}^{T} {\ddot{y}}_{i} + ρ ( {\ddot{z}}_{i}^{( ℓ )} - {\underline{u}}_{i}^{( ℓ )} ) ] , \qquad ( 45 )$$

$$i . e . ,$$

$${\underline{x}}_{i}^{( ℓ + 1 )} ← {( {D}_{i}^{H} {D}_{i} + ρ I )}^{- 1} [ {D}_{i}^{H} y ( {ω}_{i} , t ) + ρ ( {\underline{z}}_{i}^{( ℓ )} - {\underline{u}}_{i}^{( ℓ )} ) ] . \qquad ( 46 )$$

2) Construct [symbol] according to the updated rows, i.e., [symbol]
3) Update the columns of the matrix X, which is saved in the matrix Z.

Specifically,

$${\ddot{z}}_{j}^{( ℓ + 1 )} ← ( {\ddot{x}}_{j}^{( ℓ + 1 )} + {\ddot{u}}_{j}^{( ℓ )} ) , \qquad ( 47 )$$

$$i . e . ,$$

$${z}_{j}^{( ℓ + 1 )} ← ( {x}_{j}^{( ℓ + 1 )} + {u}_{j}^{( ℓ )} ) , \qquad ( 48 )$$

where the function [symbol] (x)≅(1−κ/∥x∥₂)₊x.
4) Construct [symbol] according to the updated columns, i.e., [symbol] .
5) Update the matrix U, i.e.,

$${U}^{( ℓ + 1 )} ← {U}^{( ℓ )} + {X}^{( ℓ + 1 )} - {Z}^{( ℓ + 1 )} . \qquad ( 49 )$$

6) Monitor the iterative progress and calculate the norm of the primal and the dual residuals, i.e.,

$${r}^{p r i m} = {‖ {X}^{( ℓ + 1 )} - {Z}^{( ℓ + 1 )} ‖}_{2} , \qquad ( 50 )$$

$${r}^{dual} = ρ {‖ {Z}^{( ℓ + 1 )} - {Z}^{( ℓ )} ‖}_{2} . \qquad ( 51 )$$

7) Update the parameter ρ according to

$$ρ ← \{ \begin{matrix}2 ρ , & {r}^{prim} \geq 10 {r}^{dual} \\ \frac{1}{2} ρ , & {r}^{dual} \geq 10 {r}^{prim} \\ ρ , & else\end{matrix} . \qquad ( 52 )$$

8) In the case that r^{prim}≤ϵ^{prim} and r^{dual}≤ϵ^{dual}, the iterations may be stopped; otherwise, the optimization may return to the first step.

The initialization of xᵢ and U are

$${\underline{x}}_{i}^{( 1 )} = {D}_{i}^{H} y ( {ω}_{i} , t ) , \qquad ( 1 )$$

and U⁽⁰⁾=0. According to (46), the computational cost may be very large due to the inclusion of the inverse of a matrix of size J×J. To simplify this, the matrix inverse formula may be used, i.e.,

$${( ρ I + {D}_{i}^{H} {D}_{i} )}^{- 1} = {ρ}^{- 1} [ I - {{D}_{i}^{H} ( ρ I + {D}_{i} {D}_{i}^{H} )}^{- 1} {D}_{i} ] .$$

Furthermore, according to the eigenvalue decomposition of

$${D}_{i} {D}_{i}^{H} , {D}_{i} {D}_{i}^{H} = {Q}_{i} {Λ}_{i} {Q}_{i}^{H}$$

with Λᵢ being a diagonal matrix of size M×M. Therefore, (46) may be simplified as

$${\underline{x}}_{i}^{( ℓ + 1 )} ← {ρ}^{- 1} [ I - {{T}_{i}^{H} ( {Λ}_{i} + ρ I )}^{- 1} {T}_{i} ] {\underline{t}}_{i}^{( ℓ )} , \qquad ( 53 )$$

$$where$$

$${T}_{i} {=}^{Δ} {Q}_{i}^{H} {D}_{i} , \qquad ( 54 )$$

$${y}^{″} ( {ω}_{i} , t ) {=}^{Δ} {D}_{i}^{H} y ( {ω}_{i} , t ) , \qquad ( 55 )$$

$${\underline{t}}_{i}^{( ℓ )} {=}^{Δ} {y}^{″} ( {ω}_{i} , t ) + ρ ( {\underline{z}}_{i}^{( ℓ )} - {\underline{u}}_{i}^{( ℓ )} ) . \qquad ( 56 )$$

In practical situations, the matrix Tᵢ and Λᵢ may be calculated, in advance; the vector y″(ωᵢ, t) may be calculated at each frame once. The computational cost for updating the X, the Z, and the residuals are approximately [symbol] (MJF), [symbol] (JF) and [symbol] (JF), respectively, wherein M is the number of sensors, J is the number of angle subsets, and F is the number of frequency bands.

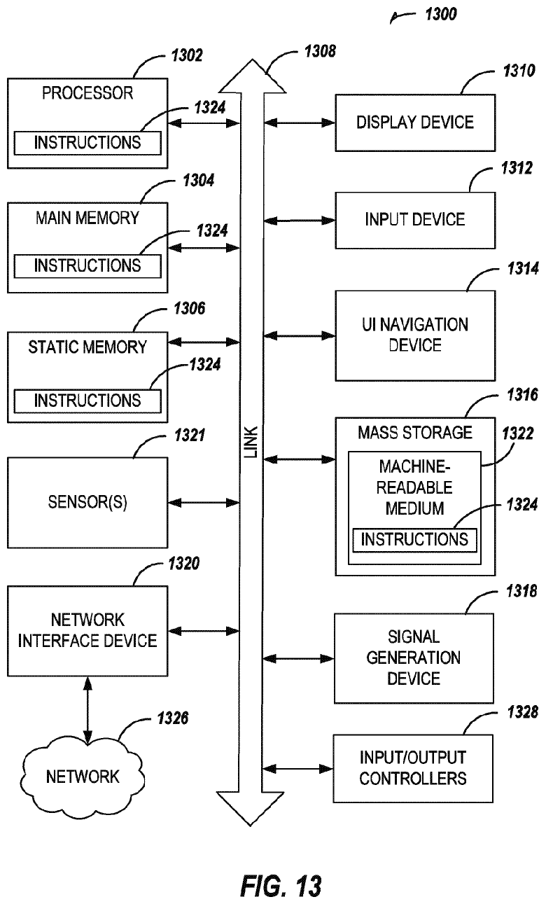

In some implementations, the target microphone array may be viewed as a virtual microphone array comprising N virtual microphones and the source microphone array and a processing device (e.g., processor 1302 of computer system 1300 of FIG. 13 as described further below) may be viewed as a virtual array system for beamforming with N virtual microphones arranged according to the most convenient array geometry for beamforming with respect to a sound source in the 3D space 100 of FIG. 1 (e.g., a virtual linear array with an endfire position directed towards sound source).

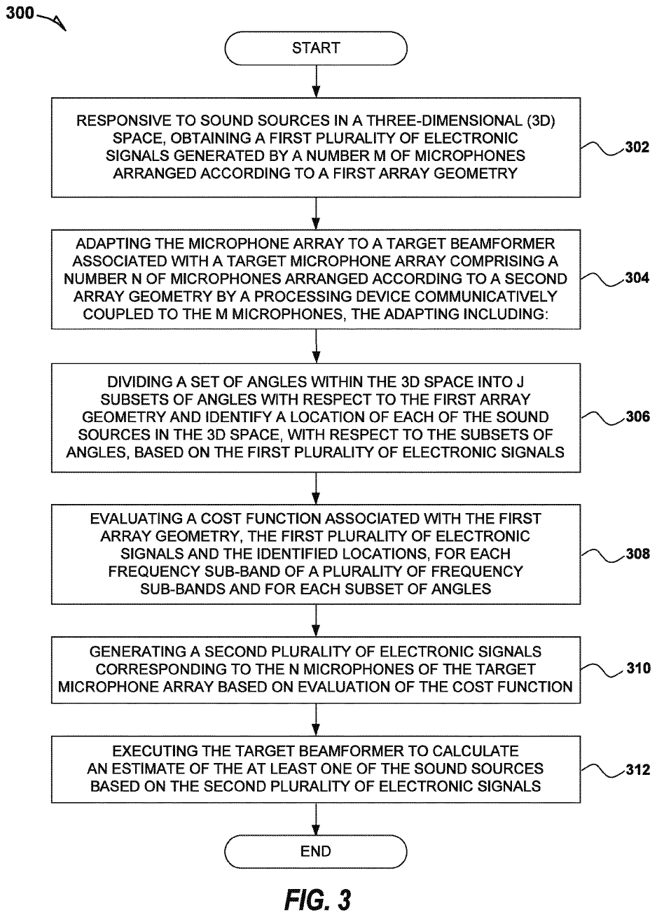

FIG. 3 shows a flow diagram of a method 300 for adapting a microphone array having a specific array geometry (e.g., array geometry of microphone array 102 of FIG. 1) to a target beamformer associated with a different microphone array geometry (e.g., target array's geometry), according to implementations of the disclosure.

A processing device (e.g., processor 1302 of computer system 1300 of FIG. 13 as described further below) communicatively coupled to a number M of microphones of a microphone array (e.g., microphone array 102 of FIG. 1) arranged according to a first array geometry (e.g., circular) may start executing operations for adapting the microphone array to a target beamformer and at 302 the processing device may, responsive to sound sources in a three-dimensional (3D) space (e.g., 3D space 100 of FIG. 1), obtain a first plurality of electronic signals generated by the M microphones.

For example, the processing device may obtain the first plurality of signal based on the sound source signals from real sound sources 104 and 106 of FIG. 1 and from the virtual sound sources based on reflections of the real sound sources in 3D space 100 of FIG. 1 (e.g., reflections from walls or other surfaces in the 3D space).

At 304, the processing device may adapt the microphone array to a target beamformer associated with a target microphone array comprising a number N microphones arranged according to a second array geometry (e.g., linear) by the processing device, the adapting including:

At 306, dividing a set of angles within the 3D space (e.g., from 0° to 360°) into J subsets of angles (e.g., 12 sets, each with a 30° range) with respect to the first array geometry and identify a location of each of the sound sources (e.g., real and virtual) in the 3D space, with respect to the subsets of angles (e.g., from which direction the sound sources impinge on the first microphone array), based on the first plurality of electronic signals.

At 308, evaluating a cost function associated with the first array geometry, the first plurality of electronic signals and the identified locations, for each frequency sub-band of a plurality of frequency sub-bands and for each subset of angles.

For example, the cost functions ƒ(X) and g(X) as described above with respect to equations (35), (36), (42), and (44) and the frequency bands F described above with respect to the computational costs of the optimization wherein the computational cost for updating the X, the Z, and the residuals were [symbol] (MJF), [symbol] (JF) and [symbol] (JF), respectively with M as the number of sensors, J as the number of angle subsets, and F as the number of frequency bands.

At 310, generating a second plurality of electronic signals corresponding to the N microphones of the target microphone array based on the evaluation of the cost function. For example, by combining (35) and (36), the matrix X may be estimated according to equations (37) and (38) as described above wherein the cost functions are re-expressed as (43) and (44) and the solution to (38) is achieved by the optimization process of equations (45)-(52).

At 312, executing the target beamformer to calculate an estimate of at least one of the sound sources (e.g., real sound source 104 and/or 106 of FIG. 1) based on the second plurality of electronic signals. The processing device may then end the operations for method 300.

### Simulations

Two microphone arrays may be considered in simulations: a uniformly-distributed circular array with six microphones (e.g., the source microphone array), and a uniform linear array with six microphones (e.g., the target microphone array). The radius of the circular array is 6 cm, and the inter-element spacing of the linear array is 2 cm. The centers of the two arrays are in the same location (e.g., within 3D space 100 of FIG. 1). Because the array transform approach does not increase the diversity of the observations (e.g., from the six microphones of the source array), but only transform them into different forms (e.g., into observation from the six microphones of the target array), the dimension of the target array should not be higher than that of the source array. The observation signal of the target array is generated based on the estimated parameters of the source array and the array geometry information. The impulse responses from the sound source to microphones may be generated by the well-known image model method, where the reflections of the ceiling and floor (e.g., the 3D space comprises a room) may be omitted to keep the simulation and analysis simple, and the reflection coefficients of the other four walls are (0.8, 0.8, 0.8, 0.8). The size of the room is 6 m×4 m×3 m. The center of the arrays is located at (3, 2, 1) in the room (e.g., x, y, z coordinates). The desired sound source is at the endfire direction of the target linear array (e.g., the target array geometry is selected for this purpose), and the distance from the sound source to the target array center is 1 m. An interference is located at the direction of 120° relative to the target array axis, and the distance from the interference to the target array is also 1 m. The background noise includes both diffuse noise and the spatially white noise, where the pseudo coherence matrix is approximately α_{dn}Γ_{dn}(ω)+(1−α_{dn})I with α_{dn}=0.99 and Γ_{dn}(ω) being the pseudo-coherence matrix of the diffuse noise. The signal-to-noise ratio, i.e., the power of the desired sound source over that of the background noise, is approximately 20 dB. The signal-to-interference ratio is approximately −3 dB. The angle domain, from 0° to 360° may be divided into 72 equally-spaced subsets, where the central angle of the j^{th} subset is φⱼ=φⱼ=5j, j=0, 1, . . . , J−1 with J=72. The array transform approach may be designed and implemented in the frequency domain and to obtain the frequency domain observation, a short-time-Fourier-transform (STFT) may be applied to the time-domain observation, where the analysis window is the Kaiser window of length 256, and the overlap rate is 75%. After applying the STFT, the Yₘ(ωᵢ, t) and the y(ωᵢ, t) may be obtained, where the frequency index i=0, 1, . . . , 128, and the frame index t=0, 1, . . . , T−1 with T being the total number of frames. Since the dynamic range of the speech signal is very large in the STFT domain, the array observation y(ωᵢ, t) may be normalized according to

$$y ( {ω}_{i} , t ) ← \frac{1}{η ( {ω}_{i} , t )} y ( {ω}_{i} , t ) \qquad ( 57 )$$

$$where$$

$$η ( {ω}_{i} , t ) {=}^{Δ} {‖ y ( {ω}_{i} , t ) ‖}_{2} . \qquad ( 58 )$$

At each frame, the corresponding X may be obtained by the proposed approach, e.g., according to (46), (48) and (49) as described above. Since the geometry of the target array is known beforehand, the matrix Aᵢ for each frequency ωᵢ is already available. According to (33), the rough estimate of z(ωᵢ, t) may then be obtained. Finally, multiplying the z(ωᵢ, t) by η(ωᵢ, t), i.e.,

$$z ( {ω}_{i} , t ) ← η ( {ω}_{i} , t ) z ( {ω}_{i} , t ) , \qquad ( 59 )$$

we get the observation of the target array in the STFT domain. By applying the inverse STFT to the z(ωᵢ, t), the time-domain observation of the target array may be obtained, which finishes the array transform from the source array geometry to the target array geometry. At each frame, X, U and Z may be initialized as

$$X = {D}_{i}^{H} y ( {ω}_{i} ) ,$$

U=0 and Z=0, respectively. To reduce the complexity, equation (53) may be applied to update X instead of equation (46). The parameter λ may be set to λ=0.1, and the initialization of the penalty factor ρ may be set to ρ=200.

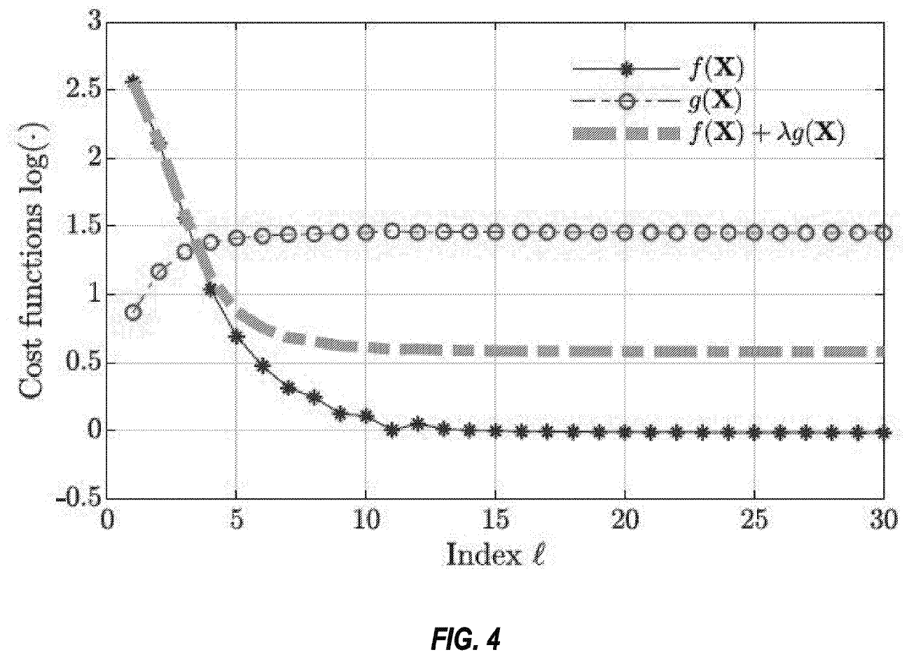

FIG. 4 shows a graph of cost functions (e.g., ƒ(X), and g(X)) as a function of the iterations of an optimization (e.g., equations (45)-(52) as described above), according to implementations of the present disclosure.

The cost functions ƒ(X), g(X) and the combined ƒ(X)+λg(X) are shown in FIG. 4 and it is clear that the total cost function ƒ(X)+λg(X) decreases as the iterations increase. The cost function ƒ(X) measures the distance between the Dᵢxᵢ and y(ωᵢ, t) at all frequencies, which also decreases with the iteration index. However, the cost function g(X) increases as the iteration process goes on. The underlying reason for this may be that the initialized ρ is very large (e.g., the initial penalty factor is ρ=200), which makes the norm of the resulting X⁽¹⁾ small according to (46). However, as the iterations increase, the penalty factor reduces, and the resulting g(X) reaches a certain level which corresponds to the minimum value of the global cost function ƒ(X)+λg(X).

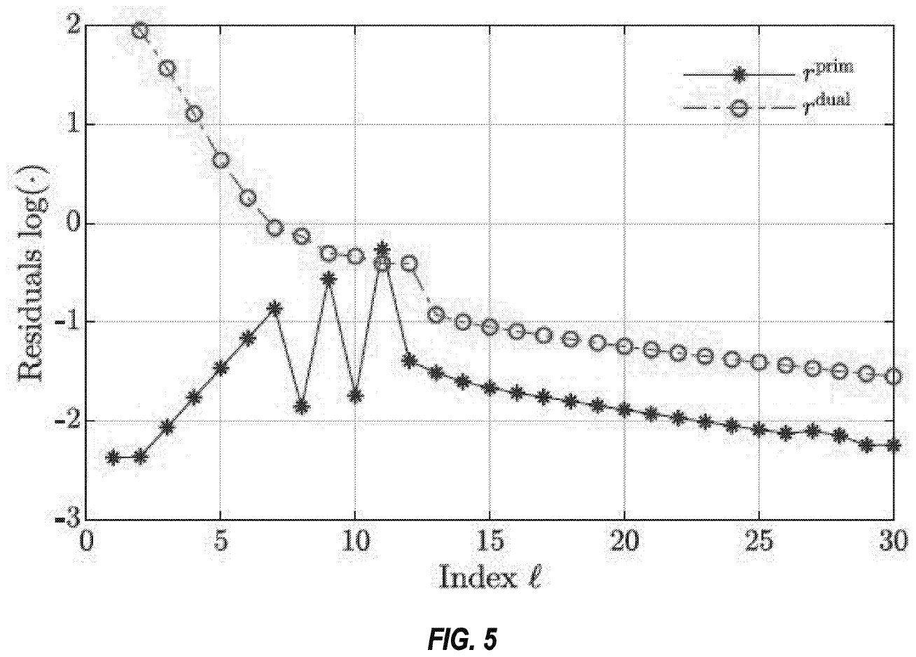

FIG. 5 shows a graph of residuals as a function of the iterations of an optimization (e.g., equations (45)-(52) as described above), according to implementations of the present disclosure. The norms of the primal and the dual residuals as a function of iteration index are shown in FIG. 5 and it is clear that the norms reduce as the iterations increase. In view of both FIG. 4 and FIG. 5, taking ϵ^{prim}=0.1 and ϵ^{dual}=0.1 may be a good choice for the stopping criterion for the iteration process.

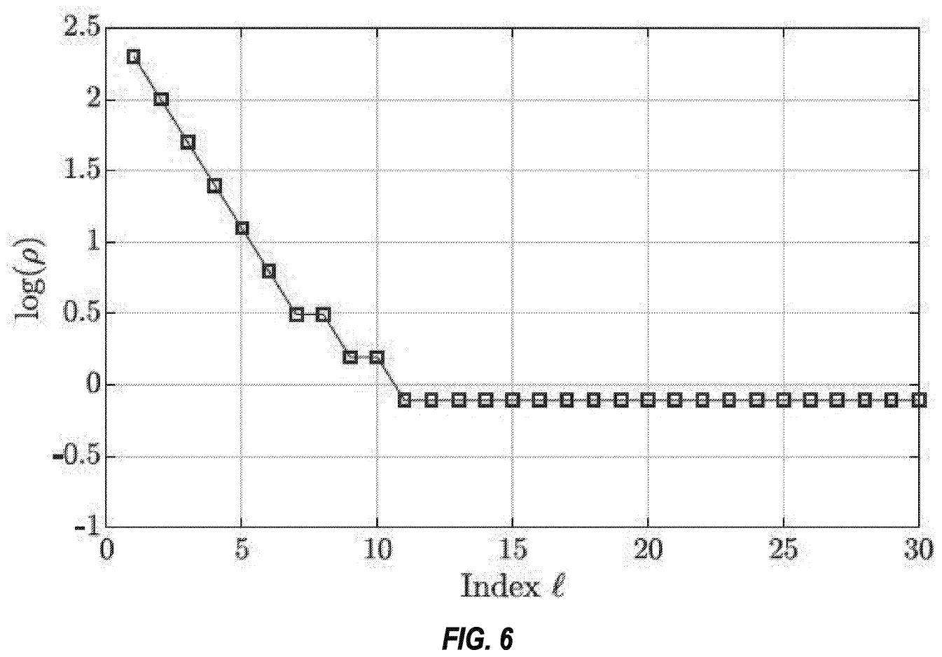

FIG. 6 shows a graph of a penalty factor ρ as a function of the iterations of an optimization (e.g., equations (45)-(52) as described above), according to implementations of the present disclosure.

For convenience, the ρ is shown as a function of the iteration index in FIG. 6. As shown, the penalty factor ρ reduces quickly with the iteration index and may not change even after several iterations.

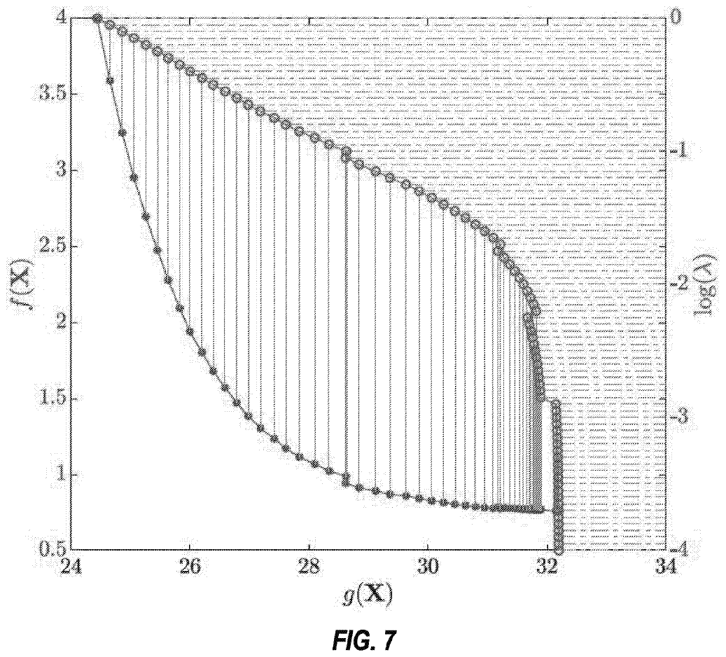

FIG. 7 shows a graph of the cost functions (e.g., ƒ(X), and g(X)) as a function of the sparseness 1 of sound sources, according to implementations of the present disclosure.

To determine the hyper-parameter λ which corresponds to the sparseness of the X, the value of ƒ(X) may be calculated with respect to g(X) as the parameter λ changes. The result is shown in FIG. 7, where it is clear that in the case that λ is very large (e.g., λ=1), further increasing its value may not reduce the g(X) (e.g., increase the sparseness), however, it will dramatically increase the cost function ƒ(X). In the case that λ is very small (e.g., λ=10⁻³) further reducing its value may not reduce the cost function ƒ(X), however, it will quickly increase the value of g(X). According to the presented results, λ=10⁻¹ may be a good value for the sparseness.

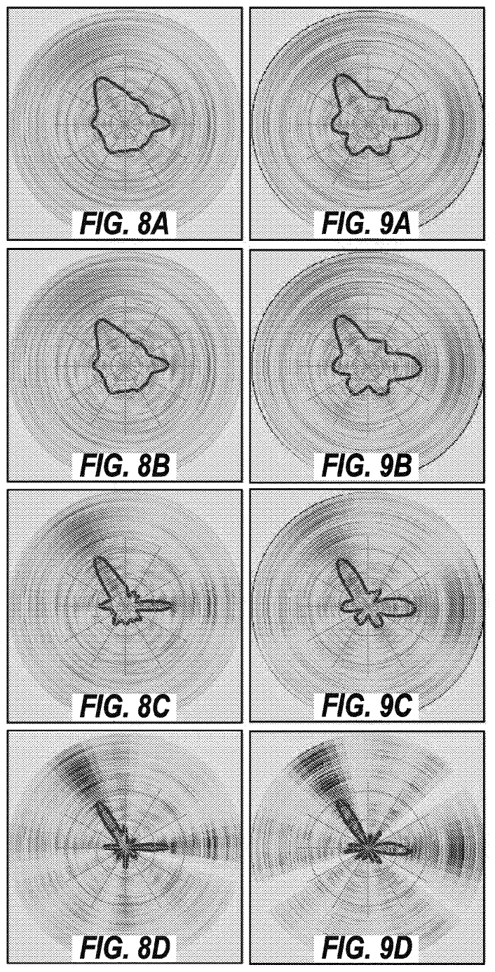

FIGS. 8A-8D show polar plots including the estimated value of weak sound sources for different levels of sound source sparseness, according to implementations of the present disclosure; and

FIGS. 9A-9D show polar plots including the estimated value of strong sound sources for different levels of sound source sparseness, according to implementations of the present disclosure.

As noted above, X may be a matrix of size F×J and the squared absolute value of its (i,j)^{th} element implies the power of the observation radiated from the direction of φⱼ and the frequency of ωᵢ, which may be viewed as the power distribution over the frequencies and angles. FIGS. 8A-8D and FIGS. 9A-9D show the power distributions of two samples of the observation with four different λ's, respectively, where the radius is the distance between the frequency of interest and the highest frequency (i.e., 8 kHz), the angle is the azimuth of the sources. FIGS. 8A-8D correspond to the weak sound sources and FIGS. 9A-9D correspond to the strong sound sources, respectively, and the λ's corresponding to (8A and 9A), (8B and 9B), (8C and 9C) and (8D and 9D) are λ=10⁻³, λ=10⁻², λ=10⁻¹, and λ=10⁰, respectively. For convenience, the full-band power distribution is plotted, which is obtained by summing the squared absolute values of the elements of the matrix X along each column. The fullband power distributions may be normalized for the convenience of presentation, and the normalization factors of different samples associated with the same λ are the same. In each polar plot, one may notice three circles with the radius of the circles from the outside to the inside being C, C/2, and C/4, respectively, where C is a constant. For the power distribution as a function of frequencies and angles, the edge of the polar plots stand for ƒ=OkHz, the outermost circle stands for ƒ=4 kHz, the second circle stands for ƒ=6 kHz, the third circle stands for ƒ=7 kHz, and the innermost point stands for ƒ=8 kHz. For the full-band distribution, the outermost circle stands for the maximum value, the second circle stands for half of the maximum value, and so on and so forth.

As shown in FIGS. 8A-8D and FIGS. 9A-9D, the power distribution with respect to the source incidence angle becomes sparser and sparser as the λ increases, and the power associated to the source and interference directions (0° and 120°) is larger than other directions. In the case that λ is very small, e.g., FIG. 8A and FIG. 9A with λ=10⁻³, the power seems to be uniformly distributed over the frequencies and angles. In the case that λ is very large, e.g., FIG. 8D and FIG. 9D with λ=10°, power concentrates on the sound source and interference directions, and information regarding any reflections of the sound source tend to be removed. According to FIG. 8C and FIG. 9C, taking λ=0.1 seems to be a good value for the sparseness.

A microphone array transform may be viewed as a multiple-input-multiple-output array processing system, where the input is the observation of the source array, and the output is the equivalent measurement of the target array. One of the most useful features of an array observation is the spatial clues of the source and interference, where the spatial clues are coded by the relative impulse responses between observations of different microphones. Therefore, the similarity of relative impulse responses may be used to show the performance of the proposed microphone array transform approach in terms of spatial clue preservation.

Assuming that two reconstructed observations zᵢ(n′) and zⱼ(n′) are available with n′ being the time index and their STFTs being Z₁(ω, t) and Z₂(ω, t). The relative impulse response \hat{r}ⱼᵢ(n′)(n′=0, 1, . . . , Lᵣ) may be defined such that

$${z}_{j} ( {n}^{′} ) = {\sum }_{k = 0}^{{L}_{r}} {\hat{r}}_{j i} ( k ) {z}_{i} ( {n}^{′} - k ) . \qquad ( 60 )$$

In the simulations, the observation of the target array may actually be generated with the same approach that applies to the source array, i.e., the image model method. Therefore, the ground truth of the relative transfer functions may be available and may be denoted as rⱼᵢ(n′). The relative transfer functions may be obtained by applying the Fourier transform to the relative impulse responses. For convenience, the relative transfer functions associated with rⱼᵢ(n′) and \hat{r}ⱼᵢ(n′) may be defined as R_{j,i}(ω) and \hat{R}_{j,i}(ω), respectively. The correlation coefficient of the relative transfer functions may then be defined as

$${𝒞}_{j , i} {=}^{Δ} \vert \frac{{\sum }_{k} {R}_{j , i} ( {ω}_{k} ) {\hat{R}}_{j , i}^{*} ( {ω}_{k} )}{\sqrt{{\sum }_{k} {\vert {R}_{j , i} ( {ω}_{k} ) \vert}^{2}} \sqrt{{\sum }_{k} {\vert {\hat{R}}_{j , i} ( {ω}_{k} ) \vert}^{2}}} \vert . \qquad ( 61 )$$

In the case that \hat{R}_{j,i}(ω)=R_{j,i}(ω), it is clear that [symbol] =1. However, generally speaking, the value of [symbol] is: 0≤ [symbol] ≤1. For the purpose of spatial clue preservation, it is desired that the value of [symbol] be as large as possible.

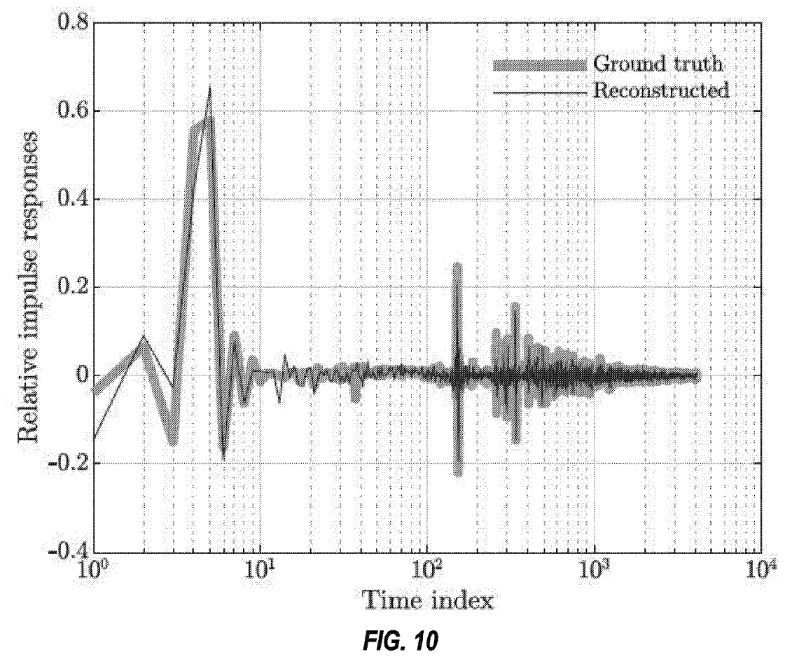

FIG. 10 shows a graph of a relative impulse responses as a function of a time index, according to implementations of the present disclosure; and

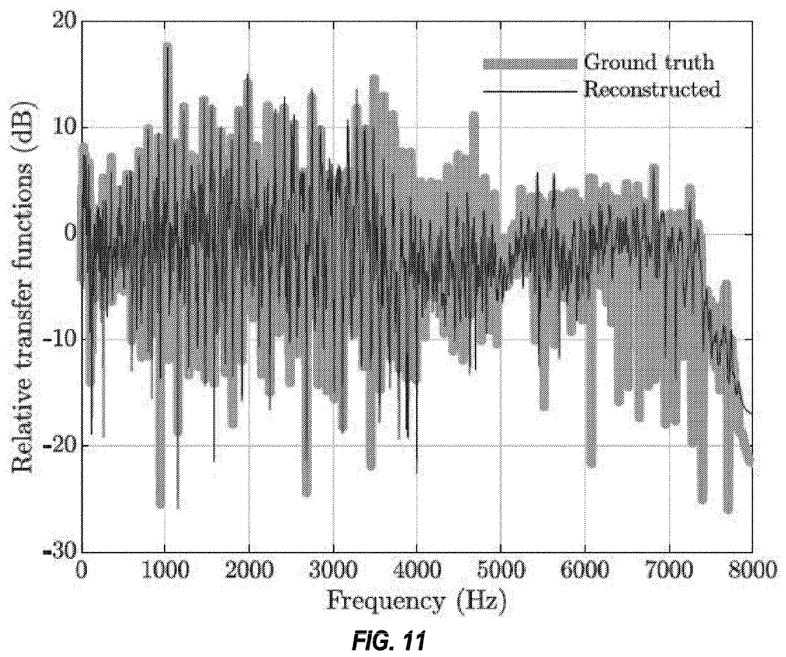

FIG. 11 shows a graph of a relative transfer functions as a function of a frequency, according to implementations of the present disclosure.

FIG. 10 and FIG. 11 respectively show the relative impulse response and the relative transfer function between the first and the last microphones of the target array, where the thicker lines correspond to ground truth. As shown in FIG. 10, the relative impulse response between the reconstructed signal matches its ground truth (see the direct-path and the large reflections) and as shown in FIG. 11 the relative transfer function also matches its ground truth well. The correlation coefficient between the reconstructed and the ground truth relative transfer functions is over 0.9 based on the observations in FIG. 11. Therefore, it is clear that the proposed array transform approach may well preserve the spatial clues of the source signals.

Beamforming may preserve the signal from the desired source direction and, at the same time, attenuate noise and interference from all other directions. In this way, the desired source signal may be enhanced in the array output. Because of the popularity of differential beamforming, different beamformers may be applied to the observation of the target array to further present the potential of the array transform. For example, the Chebyshev beampattern may be adopted as the target beampattern to design the differential beamformer of different orders. According to the order of the pattern Q, and the mainlobe width Δφ, the nulls of the Chebyshev pattern are

$${ϕ}_{n𝔲ll , q} = arccos \{ \frac{1}{a} [ cos [ \frac{2 q - 1}{2 Q} π ] ] - b \} , q = 1 , 2 , … , Q \$ , \qquad ( 62 )$$

$$where$$

$$a = \frac{2}{1 + cos Δϕ} , \qquad ( 63 )$$

$$b = \frac{1 - cos Δϕ}{1 + cos Δϕ} , \qquad ( 64 )$$

with Δφ∈(0, π), or, equivalently, (0°, 180°). Since the number of the sensors of the target array is six, the maximum order of the differential beamformer is five. In order to design the differential beamformers corresponding to the Chebyshev pattern with different order and different mainlobe width, various beamforming principles may be applied.

As noted above, the interelement spacing is 2 cm, and the frequency of interest is from 0 kHz to 8 kHz. The time-domain and frequency-domain beamforming outputs may be defined as ŝ(n) and Ŝ(ω, t), and the desired source signal may be defined as s(n) and Ŝ(ω,t). Since the array transform is not a linear process, the constructed array observation z(ω, t) may not be divided into the summation of desired source signal, interference, and background noise. Therefore, the traditional signal-to-noise ratio (SNR) and signal-to-interference ratio (SIR) may not be calculated after the differential beamforming. In order to quantify the distance between the array output and the desired source signal, the distortion may be designed as

$$\begin{matrix}v ( t ) = {min}_{α} {‖ s ( t ) - α \hat{s} ( t ) ‖}_{2}^{2} & \\ = {‖ ( I - \frac{\hat{s} ( t ) {\hat{s}}^{T} ( t )}{{\hat{s}}^{T} ( t ) \hat{s} ( t )} ) s ( t ) ‖}_{2}^{2} , & ( 66 )\end{matrix} \qquad ( 65 )$$

$$where$$

$$s ( t ) {=}^{Δ} \begin{matrix}[ \vert S ( {ω}_{0} , t ) \vert & \vert S ( {ω}_{1} , t ) \vert & … & {\vert S ( {ω}_{F - 1} , t ) \vert ]}^{T}\end{matrix} \qquad ( 67 )$$

$$\hat{s} ( t ) {=}^{Δ} \begin{matrix}[ \vert \hat{S} ( {ω}_{0} , t ) \vert & \vert \hat{S} ( {ω}_{1} , t ) \vert & … & {\vert \hat{S} ( {ω}_{F - 1} , t ) \vert ]}^{T}\end{matrix} \qquad ( 68 )$$

The signal-to-distortion index (SDI) may be defined as

$$SDI = 10 log [ \frac{1}{T} {\sum }_{t = 0}^{T - 1} \frac{{‖ s ( t ) ‖}_{2}^{2}}{{v}^{2} ( t )} ] . \qquad ( 69 )$$

Clearly, the higher the SDI, the closer the array output is to the desired sound source signal, which may imply less background noise and interference. Alternatively or together with the SDI, the short-time objective intelligibility (STOI) may be used to measure the similarity between the array output and the desired sound source signal.

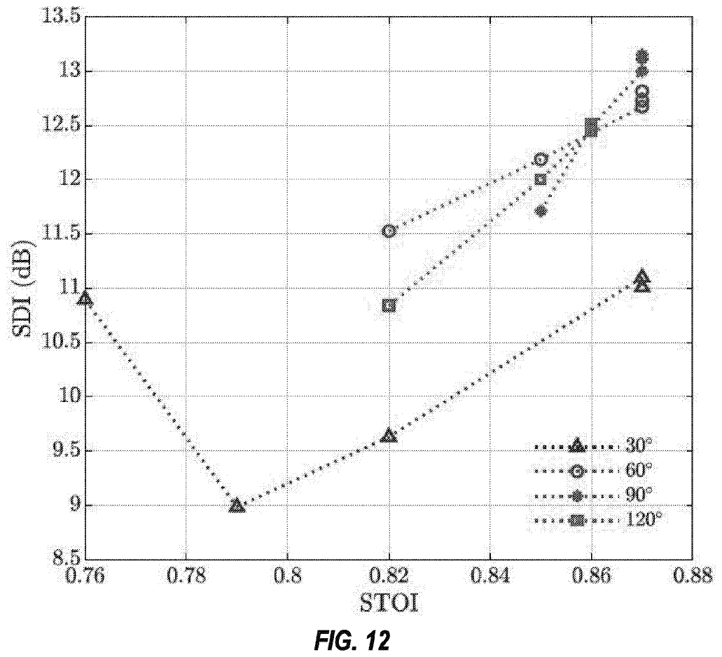

FIG. 12 shows a graph of a signal distortion index as a function of a short-time objective intelligibility (STOI), according to implementations of the present disclosure.

The above-noted SDIs and the STOIs are shown in FIG. 12, where the SDI and the STOI of the input array observations are 7.2 dB and 0.62, respectively. Generally speaking, the SDIs and STOIs increase as the order of the differential beamforming increases and their values also increase as the mainlobe width decreases (which may indicate more noise and interference attenuation). However, the performance improvement is limited once the order of differential beamforming becomes greater than three. The underlying reason for this may be that the residual interference and background noise are preserved by the mainlobe of the beampattern. In this case, further reducing the sidelobe level of the array response may only result in a minor performance improvement. Therefore, in practical real-world situations, the mainlobe width and the sidelobe level should be designed, carefully, in view of the order of the differential beamforming.

FIG. 13 is a block diagram illustrating a machine in the example form of a computer system 1300, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1300 includes at least one processor 1302 (e.g., a central processing unit (CPU), a graphics processing unit (GPU) or both, processor cores, compute nodes, etc.), a main memory 1304 and a static memory 1306, which communicate with each other via a link 1308 (e.g., bus). The computer system 1300 may further include a video display unit 1310, an alphanumeric input device 1312 (e.g., a keyboard), and a user interface (UI) navigation device 1314 (e.g., a mouse). In one embodiment, the display device 1310, input device 1312 and UI navigation device 1314 are incorporated into a touch screen display. The computer system 1300 may additionally include a storage device 1316 (e.g., a drive unit), a signal generation device 1318 (e.g., a speaker), a network interface device 1320, and one or more sensors 1321, such as a global positioning system (GPS) sensor, compass, accelerometer, gyrometer, magnetometer, or other sensor.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system 1300, with the main memory 1304, static memory 1306, and the processor 1302 also constituting machine-readable media.

While the machine-readable medium 1322 is illustrated in an example embodiment to be a single medium, the term “machine-readable medium” may include a single medium or multiple media (e.g., a centralized or distributed database, and/or associated caches and servers) that store the one or more instructions 1324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). Input/output controllers 1328 may receive input and output requests from the central processor 1302, and then send device-specific control signals to the devices they control (e.g., display device 1310). The input/output controllers 1328 may also manage the data flow to and from the computer system 1300. This may free the central processor 1302 from involvement with the details of controlling each input/output device.

Language: In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

As used in this disclosure, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A microphone array comprising:
a number M of microphones arranged according to a first array geometry; and
a processing device, communicatively coupled to the M microphones, to adapt the microphone array to a target beamformer associated with a target microphone array comprising a number N of microphones arranged according to a second array geometry, wherein N≤M, the processing device to:
responsive to sound sources in a three-dimensional (3D) space, obtain a first plurality of electronic signals generated by the M microphones;
divide a set of angles within the 3D space into J subsets of angles with respect to the first array geometry and identify a location of each of the sound sources in the 3D space, with respect to the subsets of angles, based on the first plurality of electronic signals;
evaluate a cost function associated with the first array geometry, the first plurality of electronic signals and the identified locations, for each frequency sub-band of a plurality of frequency sub-bands and for each subset of angles;
generate a second plurality of electronic signals corresponding to the N microphones of the target microphone array based on the evaluation of the cost function; and
execute the target beamformer to calculate an estimate of at least one of the sound sources based on the second plurality of electronic signals.

2. The microphone array of claim 1, wherein the first array geometry is a circular array geometry and the second array geometry is a linear array geometry.

3. The microphone array of claim 2, wherein the linear array geometry is a uniform linear array geometry with a same inter-microphone spacing.

4. The microphone array of claim 3, wherein the beamformer associated with the second array geometry is a differential beamformer implemented in a multistage cascaded manner by approximating a differential operation with a finite order difference.

5. The microphone array of claim 3, wherein the beamformer associated with the second array geometry is a differential beamformer based on maximum white noise gain (WNG) principle, zero-off-unit circle (ZOU) modification or constant pattern principle.

6. The microphone array of claim 1, wherein the sound sources include virtual sound sources based on reflections of the sound sources in the 3D space.

7. The microphone array of claim 6, wherein the 3D space includes a room with four walls, a ceiling and a roof and the reflections of the sound sources include reflections from the four walls.

8. A method for beamforming with a microphone array, comprising:
responsive to sound sources in a three-dimensional (3D) space, obtaining a first plurality of electronic signals generated by a number M of microphones arranged according to a first array geometry;
adapting the microphone array to a target beamformer associated with a target microphone array comprising a number N microphones arranged according to a second array geometry by a processing device communicatively coupled to the M microphones, the adapting including:
dividing a set of angles within the 3D space into J subsets of angles with respect to the first array geometry and identify a location of each of the sound sources in the 3D space, with respect to the subsets of angles, based on the first plurality of electronic signals;
evaluating a cost function associated with the first array geometry, the first plurality of electronic signals and the identified locations, for each frequency sub-band of a plurality of frequency sub-bands and for each subset of angles;
generating a second plurality of electronic signals corresponding to the N microphones of the target microphone array based on the evaluation of the cost function; and
executing the target beamformer associated to calculate an estimate of the at least one sound source based on the second plurality of electronic signals.

9. The method of claim 8, wherein the first array geometry is a circular array geometry and the second array geometry is a linear array geometry.

10. The method of claim 9, wherein the linear array geometry is a uniform linear array geometry with a same inter-microphone spacing.

11. The method of claim 10, wherein the beamformer associated with the second array geometry is a differential beamformer implemented in a multistage cascaded manner by approximating a differential operation with a finite order difference.

12. The method of claim 10, wherein the beamformer associated with the second array geometry is a differential beamformer based on maximum white noise gain (WNG) principle, zero-off-unit circle (ZOU) modification or constant pattern principle.

13. The method of claim 8, wherein the sound sources include virtual sound sources based on reflections of the sound sources in the 3D space.

14. The method of claim 13, wherein the 3D space includes a room with four walls, a ceiling and a roof and the reflections of the sound sources include reflections from the four walls.

15. A virtual microphone array system comprising:
a number M of microphones arranged according to a first array geometry; and
a processing device, communicatively coupled to the M microphones, to:
responsive to sound sources in a three-dimensional (3D) space, obtain a first plurality of electronic signals generated by the M microphones;
divide a set of angles in the 3D space into J subsets of angles with respect to the first array geometry and identify the location of each of the sound sources in the 3D space, with respect to the subsets of angles, based on the first plurality of electronic signals;
evaluate a cost function associated with the first array geometry, the first plurality of electronic signals and the identified locations, for each frequency sub-band of a plurality of frequency sub-bands and for each subset of angles;
generate a second plurality of electronic signals associated with N virtual microphones arranged according to a second array geometry, wherein NE M, based on the evaluation of the cost function; and
execute a beamformer associated with the second array geometry to calculate an estimate of at least one of the sound sources based on the second plurality of electronic signals.

16. The virtual microphone array system of claim 1, wherein the first array geometry is a circular array geometry and the second array geometry is a linear array geometry.

17. The virtual microphone array system of claim 2, wherein the linear array geometry is a uniform linear array geometry with a same inter-microphone spacing.

18. The virtual microphone array system of claim 3, wherein the beamformer associated with the second array geometry is a differential beamformer implemented in a multistage cascaded manner by approximating a differential operation with a finite order difference.

19. The virtual microphone array system of claim 3, wherein the beamformer associated with the second array geometry is a differential beamformer based on maximum white noise gain (WNG) principle, zero-off-unit circle (ZOU) modification or constant pattern principle.

20. The virtual microphone array system of claim 1, wherein the 3D space includes a room with four walls, a ceiling and a roof and the sound sources include virtual sound sources based on reflections of the sound sources from the four walls.
